(19) United States
(12) Patent Application Publication
(10) Pub. No.: US 2025/0211944 A1
(43) Pub. Date: Jun. 26, 2025

(54) LOCALIZATION BASED ON FLICKERING OF LIGHT WITHIN A PHYSICAL ENVIRONMENT

(71) Applicant: Apple Inc., Cupertino, CA (US)

(72) Inventors: Daniel Hellfeld, Mission Viejo, CA (US); Sam Parsa, Mountain View, CA (US)

(21) Appl. No.: 18/947,541

(22) Filed: Nov. 14, 2024

Related U.S. Application Data
(60) Provisional application No. 63/612,419, filed on Dec. 20, 2023.

(51) Int. Cl. H04W 4/029; H04B 10/114; H04B 10/116; H04L 27/06

(52) U.S. Cl. CPC H04W 4/029; H04B 10/1141; H04B 10/116; H04L 27/06

(57) ABSTRACT

Various implementations disclosed herein include devices, systems, and methods that determines a user's location within an environment using sensor data. For example, a process may obtain, via a light sensor, a signal corresponding to light flicker from one or more light sources within a physical environment. The process may further compare a characteristic of the signal associated with the light flicker from the one or more light sources with predetermined flicker profile data. The predetermined flicker profile data may identify one or more flicker attributes associated with one or more locations within the physical environment. In response to comparing the characteristic of the signal with the predetermined flicker profile data, a location of the device within the physical environment may be determined.

### CROSS-REFERENCE TO RELATED APPLICATIONS

This application claims the benefit of U.S. Provisional Application Ser. No. 63/612,419 filed Dec. 20, 2023, which is incorporated herein in its entirety.

### TECHNICAL FIELD

The present disclosure generally relates to systems, methods, and devices that determine user locations within a physical environment, for example, by utilizing characteristics of lighting within the physical environment.

### BACKGROUND

Existing techniques for determining where a user is located within a physical space, such as a home environment, may be improved with respect to accuracy, power efficiency, and other attributes.

### SUMMARY

Various implementations disclosed herein include devices, systems, and methods that determine a user (and/or device) location within an environment such as, inter alia, a room(s), etc. A user location within an environment may be determined by using a sensor that detects light flicker (e.g., amplitude modulation) of lighting within the environment that results from rectification (i.e., alternating current (AC) to direct current (DC) conversion) of power provided to a lighting source such as, inter alia, a compact fluorescent (CFL) lighting source, a light emitting diode (LED) light source, etc. Different light flicker attributes may be produced by different light sources and types and therefore different light flicker patterns (e.g., of combined light sources) may be detected at different locations within the environment.

In some implementations, a process for determining a user location within an environment may include an enrollment stage and a localization stage. During an enrollment stage, different combinations of light flicker patterns (or profiles) may be detected at different locations within the environment during user movement within the environment. The different combinations of detected light flicker patterns may be associated with corresponding (predetermined) locations referenced on a map of the environment. The predetermined or mapped light flicker pattern data for the different locations may be saved for use during a localization stage. Subsequently, during the localization stage, a currently detected light flicker pattern is compared/cross referenced to the saved mapped light flicker pattern data to determine a match that indicates a current location of the user.

In some implementations, the sensor may be a light sensor such as a light flicker detection sensor capable of detecting low and high frequency light flickering of light sources. In some implementations, light flicker samples are obtained from lighting sources and the light flicker samples are converted into a Fast Fourier transform (FFT) conversion to determine associated frequencies.

In some implementations, audio data may be obtained for use in combination with a currently detected light flicker pattern during the localization stage. For example, a currently detected light flicker pattern and a currently detected audio signal pattern may be compared/cross referenced to saved mapped light flicker and audio signal pattern data to determine a match that indicates a current location of the user.

In some implementations, image data may be obtained for use in combination with a currently detected light flicker pattern during the localization stage. For example, a currently detected light flicker pattern and currently detected image data associated with the environment may be compared/cross referenced to saved mapped light flicker and image data to determine a match that indicates a current location of the user.

In some implementations, motion sensor data may be obtained for use in combination with a currently detected light flicker pattern during the localization stage. For example, a currently detected light flicker pattern and currently detected motion sensor data associated with movement in the environment may be compared/cross referenced to saved mapped light flicker and motion sensor data to determine a match that indicates a current location of the user.

In some implementations, a device has a processor (e.g., one or more processors) that executes instructions stored in a non-transitory computer-readable medium to perform a method. The method performs one or more steps or processes. In some implementations, the device obtains, via a light sensor, a signal corresponding to light flicker from one or more light sources within a physical environment. A characteristic of the signal associated with the light flicker from the one or more light sources may be compared with predetermined flicker profile data. The predetermined flicker profile data identifies one or more flicker attributes or patterns associated with one or more locations within the physical environment. A location of the device within the physical environment may be determined based on comparing the characteristic of the signal with the predetermined flicker profile data.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIGS. 1A-B illustrate exemplary electronic devices operating in a physical environment in motion in accordance with some implementations.

FIG. 2 illustrates a system enabled analyze light flicker of lighting within an environment to determine a user and/or device location within the environment, in accordance with some implementations.

FIG. 3 illustrates an environment associated with retrieval of flicker data to be utilized with a localization process, in accordance with some implementations.

FIG. 4 illustrates an FFT plot of light flicker data retrieved from the plurality of light sources of FIG. 3, in accordance with some implementations.

FIG. 5 illustrates an alternative environment associated with retrieval of flicker data to be utilized with a localization process, in accordance with some implementations.

FIG. 6 illustrates flicker data retrieved from the plurality of light sources of the environment of FIG. 5 represented as a spectrogram, in accordance with some implementations.

FIG. 7 is a flowchart representation of an exemplary method that determines a user or device location within an environment using a sensor that detects light flicker, in accordance with some implementations.

FIG. 8 is a block diagram of an electronic device of in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

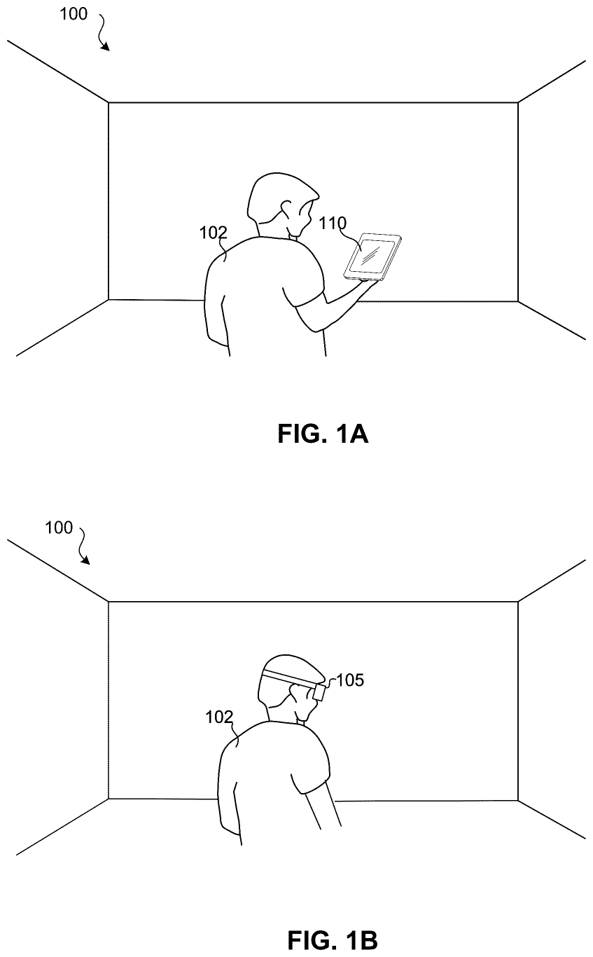

FIGS. 1A-B illustrate exemplary electronic devices 105 and 110 operating in a physical environment 100. The electronic devices 105 and 110 may include one or more cameras, microphones, depth sensors, light sensors, or other sensors that can be used to capture information about and evaluate the physical environment 100 and the objects within it, as well as information about the user 102 of electronic devices 105 and 110. The information about the physical environment 100 and/or user 102 may be used to provide visual and audio content and/or to identify the current location of the physical environment 100 and/or the location of the user within the physical environment 100.

In some implementations, views of an extended reality (XR) environment may be provided to one or more participants (e.g., user 102 and/or other participants not shown) via electronic devices 105 (e.g., a wearable device such as an HMD) and/or 110 (e.g., a handheld device such as a mobile device, a tablet computing device, a laptop computer, etc.). Such an XR environment may include views of a 3D environment that is generated based on camera images and/or depth camera images of the physical environment 100 as well as a representation of user 102 based on camera images and/or depth camera images of the user 102. Such an XR environment may include virtual content that is positioned at 3D locations relative to a 3D coordinate system associated with the XR environment, which may correspond to a 3D coordinate system of the physical environment 100.

In some implementations, video (e.g., pass-through video depicting a physical environment) is received from an image sensor of a device (e.g., device 105 or device 110). In some implementations, a 3D representation of a virtual environment is aligned with a 3D coordinate system of the physical environment. A sizing of the 3D representation of the virtual environment may be generated based on, inter alia, a scale of the physical environment or a positioning of an open space, floor, wall, etc. such that the 3D representation is configured to align with corresponding features of the physical environment. In some implementations, a viewpoint within the 3D coordinate system may be determined based on a position of the electronic device within the physical environment. The viewpoint may be determined based on, inter alia, motion sensor data, image data (e.g., retrieved via a virtual inertial odometry system (VIO), a simultaneous localization and mapping (SLAM) system, etc.).

In some implementations, a user and/or device location within an environment such as a room may be determined by utilizing low power sensors (e.g., a light flicker sensor) for localizing the user and/or device within the environment (e.g., a home or office environment). Light flicker sensors may be used to detect flickering light (from CFL light sources, LED light sources, etc.) caused by a rectified signal (i.e., an AC to DC conversion) used to power a (CFL or LED) light source. Each different light source may produce a different light flickering patterns due to different factory tolerances of components (resistors, capacitors, etc.) used in rectifier circuitry. Therefore, different light flicker patterns (e.g., of light sources) may be detected at different locations within the environment.

Determining a user or device location within an environment may include an enrollment stage and a localization stage. During an enrollment stage, different combinations of light flicker patterns of different light sources within an environment may be detected at different locations within the environment during user movement within the environment. For example, different light flicker patterns of different light sources within different rooms within a structure such as a house may be detected. The enrollment stage may comprise an active enrollment stage that includes a user specifically using a device to actively detect the different combinations of light flicker patterns. For example, a user may walk around a location(s) (e.g., a room or rooms) and actively detect (via a phone or HMD with a light flicker sensor) a position and orientation of the user with respect to an associated flickering pattern of light sources within the location. Alternatively, the enrollment stage may comprise a passive enrollment stage that includes a user using a device to passively detect the different combinations of light flicker patterns as background operations performed over time during normal operational usage of the device. The different combinations of light flicker patterns may be associated with corresponding locations referenced on a map of the environment and the mapped light flicker pattern data for the different locations may be saved for use during the localization stage.

Subsequently, during the localization stage, a currently detected light flicker pattern is cross referenced with the saved light flicker pattern data mapped to corresponding locations on a map of the environment to determine a match that indicates a current location of the user.

In some implementations, a sensor to detect light flicker patterns may be a light sensor such as a light flicker detection sensor capable of detecting low and high frequency light flickering of light sources. In some implementations, light flicker samples are obtained from lighting sources and the light flicker samples are converted into a Fast Fourier transform (FFT) conversion to determine associated frequencies.

In some implementations, sensor fusion may be implemented to collect data from audio sensors, image sensors, motion sensors, magnetometer sensors, Wi-Fi sensors, etc. to be used in combination with a currently detected light flicker pattern to provide a current location of the user. For example, a currently detected light flicker pattern and currently detected audio, image, motion, etc. signal patterns may be compared/cross referenced to saved mapped signal pattern data to determine a match that indicates a current location of the user. In some implementations, an extended Kalman filter (EKF) or particle filter may be used during sensor fusion to combine sensor data from various sensors. For example, an EKF may be configured to produce a motion estimation, while a particle filter may be configured to update a state based on maps being generated from various sensor data. In some implementations, environmental data, such as ambient light sensor (ALS) data or a state of smart home devices (e.g., lights) may be used to determine when to query a light flicker sensor.

In some implementations, the saved light flicker pattern data mapped to corresponding locations on a map of the environment may comprise a 3-dimensional (3D) map (e.g., six-degrees-of-freedom (6DOF) poses and associated flicker signatures) of flicker signatures in 3D space, thereby allowing for localization in three dimensions. Therefore, as users move around and occupy different positions, a corresponding flicker signature pattern may be correlated with the 3D map.

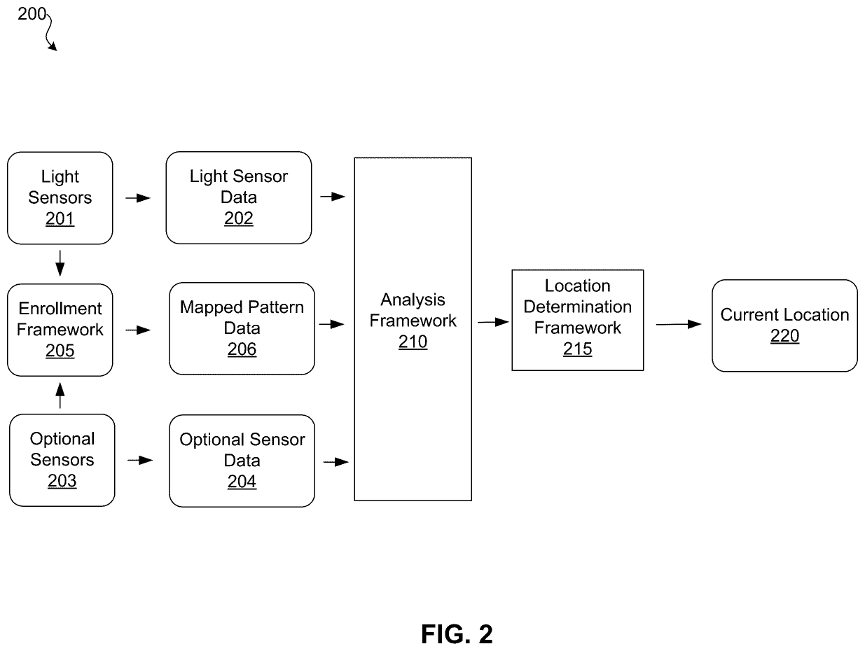

FIG. 2 illustrates a system 200 enabled analyze light flicker of lighting within an environment to determine a user and/or device location within the environment, in accordance with some implementations. System 200 is configured to utilize light sensor data 202 from light sensors 201 (e.g., light flicker sensors) to detect light flicker patterns of LED and/or CFL lighting within an environment such as, inter alia, a house, a room(s), an office space, etc. The light flicker patterns are used to determine a current location 220 of a user within the environment. Light flicker of LED and/or CFL lighting may be caused by an initial AC current being rectified into a DC current to power the LED and/or CFL lighting. The AC current being rectified into a DC current may cause residual current variations that may create the light flicker patterns/frequencies that may be imperceptible to the human eye.

The aforementioned flicker patterns may be used as unique fingerprints for localization. For example, analyzing the frequency and modulation of a flicker pattern, enables different LED and/or CFL light sources to be differentiated from each other even if the light sources are produced from a same manufacturer and/or batch. Results of the analysis may be used to determine current location 220 of a user.

In some implementations, light sensor data 202 is retrieved from light sensors 201 such as, inter alia light flicker sensors, to detect light flicker patterns of LED and/or CFL lighting within an environment. Subsequently, the light sensor data 202 is input into an analysis framework 210 to analyze the light flicker patterns of the light sensor data 202. For example, a Fast Fourier Transform (FFT) may be used to analyze the light flicker patterns to determine that different light sources exhibit distinct frequency patterns which may serve as a basis for localization. Likewise, a spectrogram (i.e., a visual representation of a spectrum of frequencies) may be generated to enable visualization associated with differing flickering patterns changing over time and space, thereby further enhancing a user/device localization process. Light sensor data 202 may be retrieved/utilized periodically rather than continuously to conserve power (e.g., of an HMD).

In some implementations, a sensor fusion strategy is enabled such that data from multiple sensors are combined to improve an accuracy and reliability of a user/device localization process. For example, optional sensor data 204 may be retrieved from optional sensors 203 such as, inter alia, audio/acoustic sensors, image sensors, motion sensors, magnetic field sensors to map the magnetic field in the environment, inertial sensors to utilize inertial odometry to track motion, ALS (ambient light) sensors to capture a unique color spectrum, Wi-Fi sensors to create maps of Wi-Fi signal strengths in the environment, etc. The optional sensor data 204 may be input into analysis framework 210 to be used in combination with light sensor data 202 for analysis to provide a location of user/device.

In some implementations, a currently detected light flicker pattern and/or currently detected audio, image, motion, etc. signal patterns may be compared or cross referenced (via analysis framework 210) to saved mapped signal pattern data 206 to determine a match (via location determination framework 215) that indicates a current location 220 of the user. The comparison may be used to determine a difference between signal profiles of the currently detected light flicker pattern and the saved mapped signal pattern data 206 with respect to: an entire signal spectrum, a specified time period, a level above or below a specified signal threshold, etc. For example, amplitudes and/or periods of the currently detected light flicker pattern may be compared to amplitudes and/or periods of saved mapped signal pattern data 206.

Mapped signal pattern data 206 may be generated during an enrollment process for initially retrieving sensor data to use for generating mapped signal pattern data 206 via an enrollment framework 205. The enrollment process may comprise an active enrollment process or a passive enrollment process. During an active enrollment process, users may actively participate in mapping their environment (e.g., rooms in a house) by providing data related to their movement and pose while actively using their devices. The resulting retrieved data may be used to build an initial mapped understanding of the environment. During a passive enrollment process sensor data may collected in the background during normal user operation of a device without active user involvement. Therefore, during a timeframe such as a few days or a few weeks, enrollment framework 205 may implicitly estimate a user's position and collect associated flicker data and/or another type of sensor data to build an initial mapped understanding of the environment. For example, computer vision and pattern recognition (CV) techniques may be utilized to identify a room type such as, inter alia, a kitchen, a living room, a bedroom, an office, etc. Likewise, additional sensor data such as, inter alia, audio data (e.g., cooking sounds, blender noise, refrigerator noise, etc.) and/or inertial measurement unit (IMU) data may be utilized to identify a room type. Additionally or alternatively cluster data may be utilized to detect a specific location that the device has been detected in at a previous time.

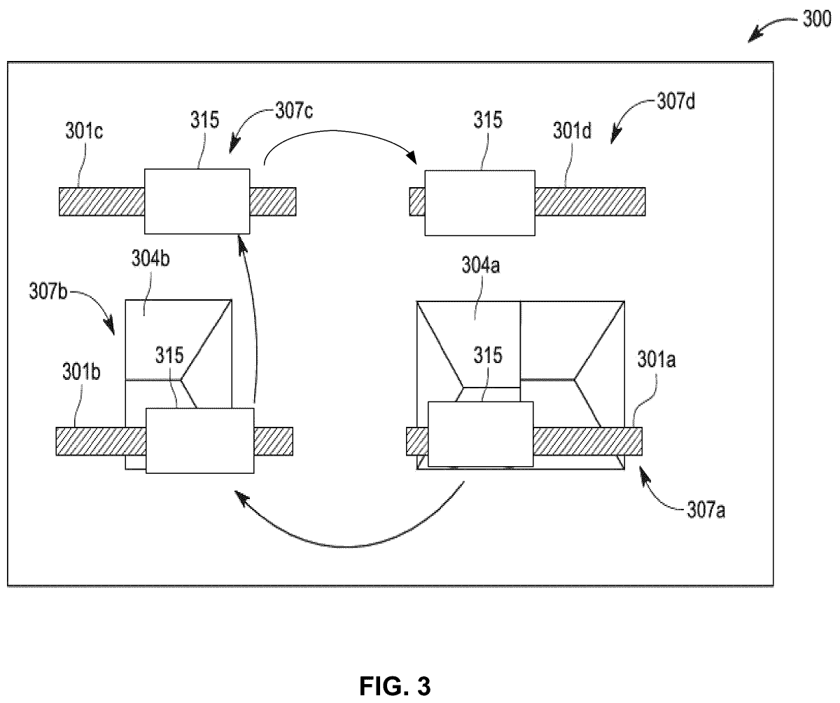

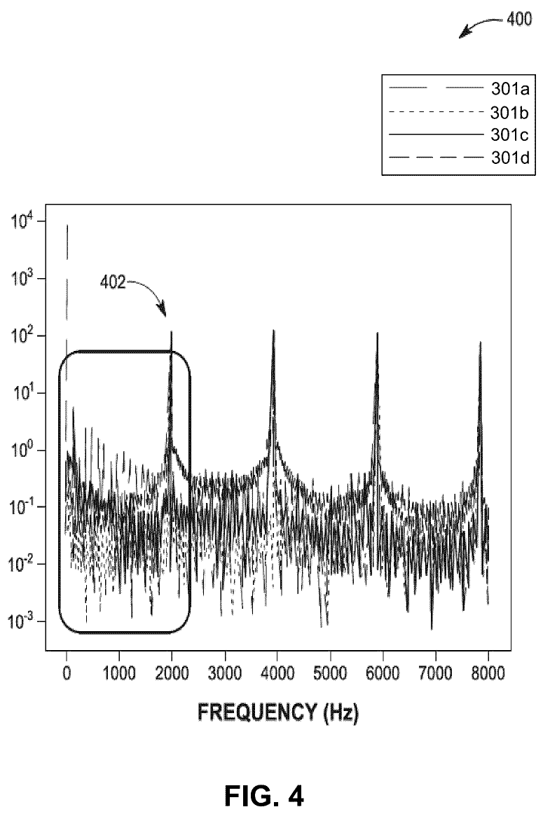

FIG. 3 illustrates an environment 300 associated with retrieval of flicker data to be utilized as enrollment data for a localization process, in accordance with some implementations. The flicker data is retrieved, via a device 315 (e.g., a mobile device such as, inter alia, an HMD, a cellular device, a tablet computer, etc.) comprising a flicker sensor, from a plurality of light sources 301a-301d located in positions with respect to office space 307a-307d and/or cubicles 304a-304b. In this implementation, device 315 with a flicker sensor may be positioned on a user's head and is pointed in an upward direction towards the light sources 301a-301d (moving sequentially from light source 301a-301d) for a specified time period to obtain flicker measurements for plotting as described with respect to FIG. 4, infra.

FIG. 4 illustrates an FFT plot 400 of light flicker data 402 retrieved from the plurality of light sources 301a-301d of FIG. 3, in accordance with some implementations. The X-axis of FFT plot 400 represents frequency and the Y-axis represents amplitude. FFT 400 plot enables a single scalar value (e.g., sampled at 16 kHz) to be extracted from light flicker data 402 utilizing an onboard analog to digital converter (ADC). FFT plot 400 illustrates a frequency spectrum comprising a dominant flicker frequency of around 120 Hertz for a 60 Hertz AC signal. FFT plot 400 of light flicker data 402 represents different frequency patterns illustrating that each one of the plurality of light sources 301a-301d may look slightly different in a frequency space.

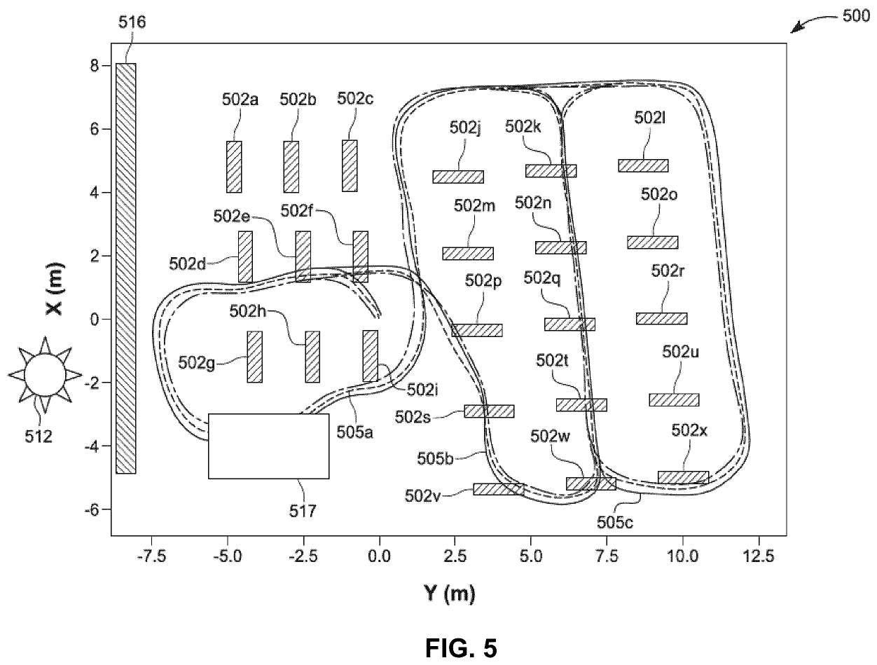

FIG. 5 illustrates a plot of an environment 500 associated with retrieval of flicker data to be utilized with a localization process, in accordance with some implementations. Environment 500 comprises light sources 502a-502x (e.g., CFL or LED). The flicker data is retrieved, via a device 517 (e.g., a mobile device such as, inter alia, an HMD, a cellular device, a tablet computer, etc.) comprising a flicker sensor, from light sources 502g-502x (e.g., CFL or LED) located in positions with respect to office space and/or cubicles. In contrast to the implementation of FIG. 3, the implementation illustrated in FIG. 5 is associated with a user wearing device 517 (e.g., an HMD) and walking around areas 505a, 505b, and 505c (additionally comprising natural light 512 via a window 516) with their head pointed in a forward direction instead up the upward direction as described with respect to FIG. 3.

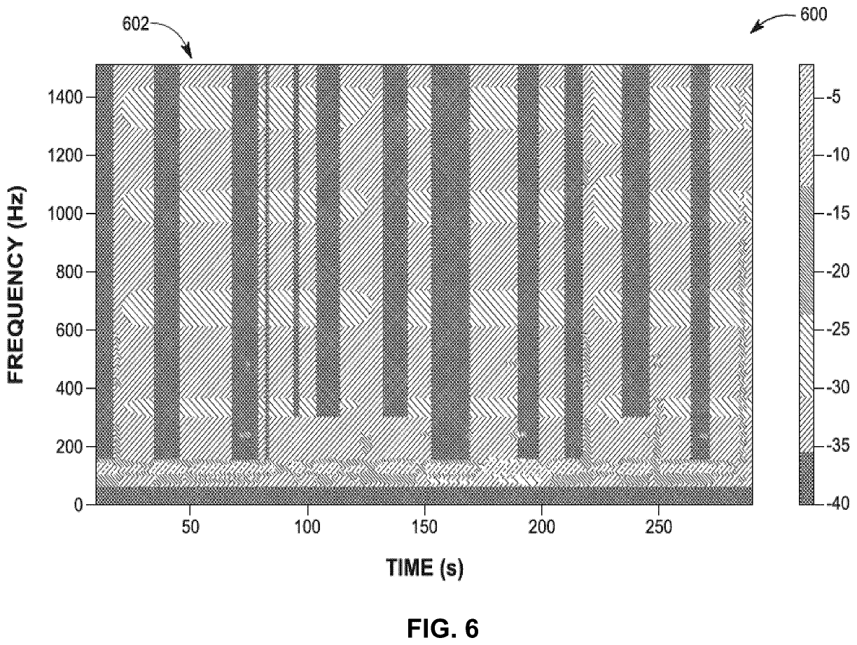

FIG. 6 illustrates flicker data 602 retrieved from the plurality of light sources 502a-502n of environment 500 of FIG. 5 run through an FFT to generate a spectrogram 600 plotted as a function of time, in accordance with some implementations. The X-axis of spectrogram 600 represents time and the Y-axis represents frequency. Spectrogram 600 represents different time segments associated with modulation within an FFT signal to infer a user/device location. The process to infer a user/device location may include an initial enrollment stage that enables different combinations of light flicker patterns to be detected at different locations within environment 500 (of FIG. 5) during user movement within environment 500. The different combinations of detected light flicker patterns may be associated with corresponding locations referenced on a map of the environment 500. The mapped light flicker pattern data for the different locations may be saved for use during a localization stage. Subsequently, during the localization stage, a currently detected light flicker pattern and/or any additional sensor data is compared/cross referenced to the saved mapped light flicker pattern data and any additional sensor data to determine a match that indicates a current location of the user.

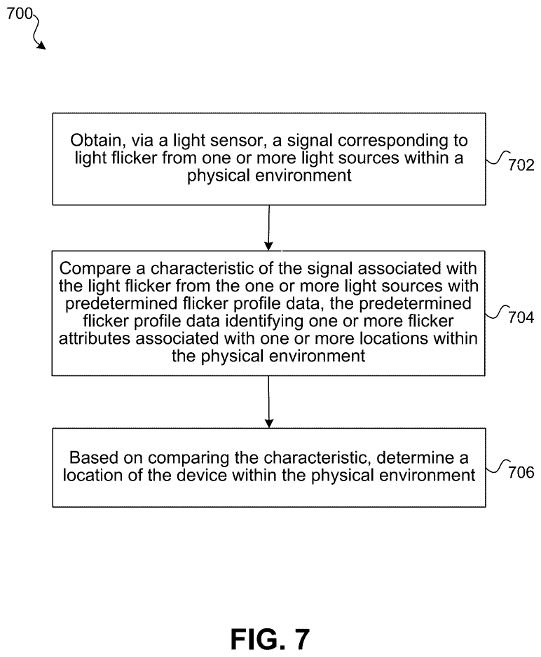

FIG. 7 is a flowchart representation of an exemplary method 700 that determines a user or device location within an environment using a sensor that detects light flicker, in accordance with some implementations. In some implementations, the method 700 is performed by a device, such as a mobile device, desktop, laptop, HMD, or server device. In some implementations, the device has a screen for displaying images and/or a screen for viewing stereoscopic images such as a head-mounted display (HMD such as e.g., device 105 or 110 of FIGS. 1A and 1B). In some implementations, the method 700 is performed by processing logic, including hardware, firmware, software, or a combination thereof. In some implementations, the method 700 is performed by a processor executing code stored in a non-transitory computer-readable medium (e.g., a memory). Each of the blocks in the method 700 may be enabled and executed in any order.

At block 702, the method 700 obtains, via device associated with a light sensor such as inter alia a light flicker sensor, a signal corresponding to light flicker from one or more light sources within a physical environment. For example, light flicker data 402 that includes light flicker patterns of LED and/or CFL lighting caused by an initial AC current being rectified into a DC current to power the lighting as described with respect to FIGS. 2 and 4. The device may be, inter alia, an HMD, a mobile device, etc. The light sensor may be integrated with the device.

At block 704, the method 700 compares a characteristic of the signal associated with the light flicker from the one or more light sources with predetermined flicker profile data and/or mapped flicker pattern data. For example, light signal patterns or profiles may be compared or cross referenced (via an analysis framework 210) to saved mapped or profiled signal pattern data 206 as described with respect to FIG. 2. The mapped flicker pattern data (and/or predetermined flicker profile data) identifies one or more flicker patterns (or random data snapshots) associated with one or more locations within the physical environment.

In some implementations, the mapped flicker data and/or predetermined flicker profile data may be generated during an initial enrollment process based on detecting the one or more flicker patterns or data snapshots from the one or more light sources within the one or more locations within the physical environment. For example, an enrollment process may be enabled via an enrollment framework 205 as described with respect to FIG. 2. The enrollment process may include an active enrollment process that includes using the device to actively enable the detecting. Alternatively, the enrollment process may include a passive enrollment process that includes using the device to passively enable detecting the one or more flicker patterns or predetermined flicker profiles as a background operation performed over time during operational usage of the device.

In some implementations, the mapped flicker pattern data or predetermined flicker profiles may be adjusted (e.g., as user scans a room as described with respect to FIGS. 1A and 1B) based on detecting a new or different flicker pattern or profile at a first location within the physical environment. For example, an initial match was detected between the mapped flicker pattern data or profile and a characteristic of a signal associated with detected light flicker from light sources but a subsequent match is no longer detected. Likewise, additional sensor data indicates that the device is in a same location as it was during the initial match. Therefore, an update may be triggered with respect to the mapped flicker pattern or profile data to indicate that there are multiple differing flicker patterns for the current location.

In some implementations, the characteristic of the signal may be a Fast Fourier transform (FFT) conversion of the signal. For example, an FFT plot 400 of light flicker data 402 retrieved from plurality of light sources 301a-301d as described with respect to FIGS. 3 and 4. In some implementations, a spectrogram (i.e., a visual representation of a spectrum of frequencies) may be generated to enable visualization associated with differing flickering patterns (of the signal corresponding to light flicker) changing over time and space.

At block 706, the method 700 determines a location of the device within the physical environment based on results of the comparison of step 704. Determining the location of the device may include determining 2D or 3D location and/or orientation of the device. For example, a currently detected light flicker pattern and/or any additional sensor data may by compared/cross referenced to saved mapped light flicker pattern data and any additional sensor data to determine a match that indicates a current location of the user as described with respect to FIG. 6.

In some implementations, determining the location of the device within the physical environment is further based on audio data obtained within the physical environment.

In some implementations, determining the location of the device within the physical environment is further based on image data obtained within the physical environment.

In some implementations, determining the location of the device within the physical environment is further based on motion sensor data obtained within the physical environment.

In some implementations, determining the location of the device within the physical environment is further based on sensor data, from multiple sensors, periodically changing over time.

In some implementations, determining the location of the device within the physical environment is further based on additional localization events.

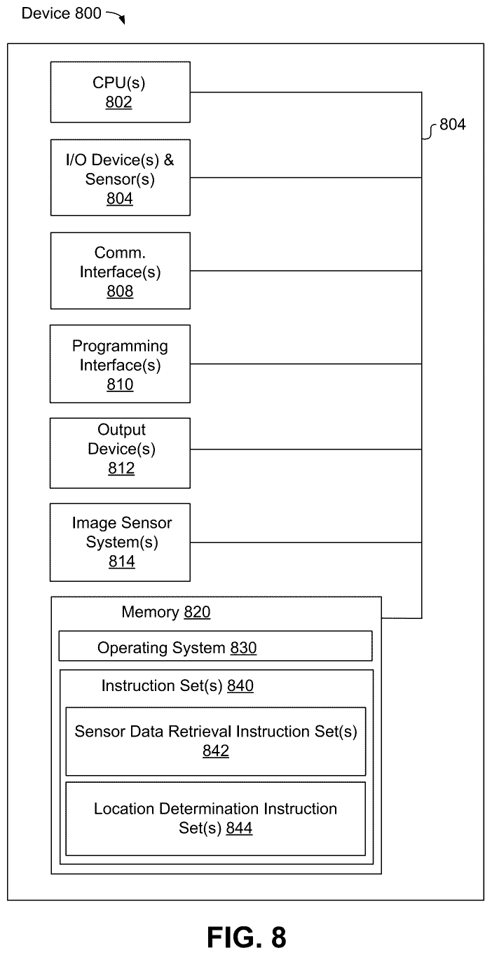

FIG. 8 is a block diagram of an example device 800. Device 800 illustrates an exemplary device configuration for electronic devices 105 and 110 of FIG. 1. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 800 includes one or more processing units 802 (e.g., microprocessors, ASICs, FPGAs, GPUs, CPUs, processing cores, and/or the like), one or more input/output (I/O) devices and sensors 804, one or more communication interfaces 808 (e.g., USB, FIREWIRE, THUNDERBOLT, IEEE 802.3x, IEEE 802.11x, IEEE 802.14x, GSM, CDMA, TDMA, GPS, IR, BLUETOOTH, ZIGBEE, SPI, I2C, and/or the like type interface), one or more programming (e.g., I/O) interfaces 810, output devices (e.g., one or more displays) 812, one or more interior and/or exterior facing image sensor systems 814, a memory 820, and one or more communication buses 804 for interconnecting these and various other components.

In some implementations, the one or more communication buses 804 include circuitry that interconnects and controls communications between system components. In some implementations, the one or more I/O devices and sensors 806 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), one or more cameras (e.g., inward facing cameras and outward facing cameras of an HMD), one or more infrared sensors, one or more heat map sensors, and/or the like.

In some implementations, the one or more displays 812 are configured to present a view of a physical environment, a graphical environment, an extended reality environment, etc. to the user. In some implementations, the one or more displays 812 are configured to present content (determined based on a determined user/object location of the user within the physical environment) to the user. In some implementations, the one or more displays 812 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some implementations, the one or more displays 812 correspond to diffractive, reflective, polarized, holographic, etc. waveguide displays. In one example, the device 800 includes a single display. In another example, the device 800 includes a display for each eye of the user.

In some implementations, the one or more image sensor systems 814 are configured to obtain image data that corresponds to at least a portion of the physical environment 100. For example, the one or more image sensor systems 814 include one or more RGB cameras (e.g., with a complimentary metal-oxide-semiconductor (CMOS) image sensor or a charge-coupled device (CCD) image sensor), monochrome cameras, IR cameras, depth cameras, event-based cameras, and/or the like. In various implementations, the one or more image sensor systems 814 further include illumination sources that emit light, such as a flash. In various implementations, the one or more image sensor systems 814 further include an on-camera image signal processor (ISP) configured to execute a plurality of processing operations on the image data.

In some implementations, sensor data may be obtained by device(s) (e.g., devices 105 and 110 of FIG. 1) during a scan of a room of a physical environment. The sensor data may include a 3D point cloud and a sequence of 2D images corresponding to captured views of the room during the scan of the room. In some implementations, the sensor data includes image data (e.g., from an RGB camera), depth data (e.g., a depth image from a depth camera), ambient light sensor data (e.g., from an ambient light sensor), and/or motion data from one or more motion sensors (e.g., accelerometers, gyroscopes, IMU, etc.). In some implementations, the sensor data includes visual inertial odometry (VIO) data determined based on image data. The 3D point cloud may provide semantic information about one or more elements of the room. The 3D point cloud may provide information about the positions and appearance of surface portions within the physical environment. In some implementations, the 3D point cloud is obtained over time, e.g., during a scan of the room, and the 3D point cloud may be updated, and updated versions of the 3D point cloud obtained over time. For example, a 3D representation may be obtained (and analyzed/processed) as it is updated/adjusted over time (e.g., as the user scans a room).

In some implementations, sensor data may be positioning information, some implementations include a VIO to determine equivalent odometry information using sequential camera images (e.g., light intensity image data) and motion data (e.g., acquired from the IMU/motion sensor) to estimate the distance traveled. Alternatively, some implementations of the present disclosure may include a simultaneous localization and mapping (SLAM) system (e.g., position sensors). The SLAM system may include a multidimensional (e.g., 3D) laser scanning and range-measuring system that is GPS independent and that provides real-time simultaneous location and mapping. The SLAM system may generate and manage data for a very accurate point cloud that results from reflections of laser scanning from objects in an environment. Movements of any of the points in the point cloud are accurately tracked over time, so that the SLAM system can maintain precise understanding of its location and orientation as it travels through an environment, using the points in the point cloud as reference points for the location.

In some implementations, the device 800 includes an eye tracking system for detecting eye position and eye movements (e.g., eye gaze detection). For example, an eye tracking system may include one or more infrared (IR) light-emitting diodes (LEDs), an eye tracking camera (e.g., near-IR (NIR) camera), and an illumination source (e.g., an NIR light source) that emits light (e.g., NIR light) towards the eyes of the user. Moreover, the illumination source of the device 800 may emit NIR light to illuminate the eyes of the user and the NIR camera may capture images of the eyes of the user. In some implementations, images captured by the eye tracking system may be analyzed to detect position and movements of the eyes of the user, or to detect other information about the eyes such as pupil dilation or pupil diameter. Moreover, the point of gaze estimated from the eye tracking images may enable gaze-based interaction with content shown on the near-eye display of the device 800.

The memory 820 includes high-speed random-access memory, such as DRAM, SRAM, DDR RAM, or other random-access solid-state memory devices. In some implementations, the memory 820 includes non-volatile memory, such as one or more magnetic disk storage devices, optical disk storage devices, flash memory devices, or other non-volatile solid-state storage devices. The memory 820 optionally includes one or more storage devices remotely located from the one or more processing units 802. The memory 820 includes a non-transitory computer readable storage medium.

In some implementations, the memory 820 or the non-transitory computer readable storage medium of the memory 820 stores an optional operating system 830 and one or more instruction set(s) 840. The operating system 830 includes procedures for handling various basic system services and for performing hardware dependent tasks. In some implementations, the instruction set(s) 840 include executable software defined by binary information stored in the form of electrical charge. In some implementations, the instruction set(s) 840 are software that is executable by the one or more processing units 802 to carry out one or more of the techniques described herein.

The instruction set(s) 840 includes a sensor data retrieval instruction set 842 and a location determination instruction set 844. The instruction set(s) 840 may be embodied as a single software executable or multiple software executables.

The sensor data retrieval instruction set 842 is configured with instructions executable by a processor to obtain (via a sensor such as a light sensor) a signal corresponding to light flicker from one or more light sources within a physical environment.

The location determination instruction set 844 is configured with instructions executable by a processor to determine a location of a user and/or device within the physical environment based on sensed light flicker within the physical environment.

Although the instruction set(s) 840 are shown as residing on a single device, it should be understood that in other implementations, any combination of the elements may be located in separate computing devices. Moreover, FIG. 8 is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

Those of ordinary skill in the art will appreciate that well-known systems, methods, components, devices, and circuits have not been described in exhaustive detail so as not to obscure more pertinent aspects of the example implementations described herein. Moreover, other effective aspects and/or variants do not include all of the specific details described herein. Thus, several details are described in order to provide a thorough understanding of the example aspects as shown in the drawings. Moreover, the drawings merely show some example embodiments of the present disclosure and are therefore not to be considered limiting.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, e.g., one or more modules of computer program instructions, encoded on computer storage medium for execution by, or to control the operation of, data processing apparatus. Alternatively, or additionally, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel. The operations described in this specification can be implemented as operations performed by a data processing apparatus on data stored on one or more computer-readable storage devices or received from other sources.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method comprising:
at a device having a processor:
obtaining, via a light sensor, a signal corresponding to light flicker from one or more light sources within a physical environment;
comparing a characteristic of the signal associated with the light flicker from the one or more light sources with predetermined flicker profile data, the predetermined flicker profile data identifying one or more flicker attributes associated with one or more locations within the physical environment; and
based on the comparing, determining a location of the device within the physical environment.

2. The method of claim 1, wherein the predetermined flicker profile data is generated during an enrollment process based on detecting the one or more flicker attributes from the one or more light sources within the one or more locations within the physical environment.

3. The method of claim 2, wherein the enrollment process is an active enrollment process that includes using the device to actively enable the detecting.

4. The method of claim 2, wherein the enrollment process is a passive enrollment process that includes using the device to passively enable the detecting as background operations performed over time during operational usage of the device.

5. The method of claim 1, further comprising adjusting the predetermined flicker profile data based on detecting a new or different flicker attribute at a first location within the physical environment.

6. The method of claim 1, wherein the characteristic of the signal is a Fast Fourier transform (FFT) conversion of the of the signal.

7. The method of claim 1, wherein the characteristic of the signal is used to generate a spectrogram associated with differing flickering patterns, associated with the signal corresponding to the light flicker, changing over time and space.

8. The method of claim 1, wherein said determining the location of the device within the physical environment is further based on audio data obtained within the physical environment.

9. The method of claim 1, wherein said determining the location of the device within the physical environment is further based on image data obtained within the physical environment.

10. The method of claim 1, wherein said determining the location of the device within the physical environment is further based on motion sensor data obtained within the physical environment.

11. The method of claim 1, wherein said determining the location of the device within the physical environment is further based on sensor data, from multiple sensors, periodically changing over time.

12. The method of claim 1, wherein said determining the location of the device within the physical environment is further based on additional localization events.

13. The method of claim 1, wherein the light sensor is integrated with the device.

14. A device comprising:
a non-transitory computer-readable storage medium; and
one or more processors coupled to the non-transitory computer-readable storage medium, wherein the non-transitory computer-readable storage medium comprises program instructions that, when executed on the one or more processors, cause the electronic device to perform operations comprising:
obtaining, via a light sensor, a signal corresponding to light flicker from one or more light sources within a physical environment;
comparing a characteristic of the signal associated with the light flicker from the one or more light sources with predetermined flicker profile data, the predetermined flicker profile data identifying one or more flicker attributes associated with one or more locations within the physical environment; and
based on the comparing, determining a location of the device within the physical environment.

15. The device of claim 14, wherein the predetermined flicker profile data is generated during an enrollment process based on detecting the one or more flicker attributes from the one or more light sources within the one or more locations within the physical environment.

16. The device of claim 15, wherein the enrollment process is an active enrollment process that includes using the device to actively enable the detecting.

17. The device of claim 15, wherein the enrollment process is a passive enrollment process that includes using the device to passively enable the detecting as background operations performed over time during operational usage oof the device.

18. The device of claim 14, wherein the program instructions, when executed on the one or more processors, further cause the electronic device to perform operations comprising:
adjusting the predetermined flicker profile data based on detecting a new or different flicker attribute at a first location within the physical environment.

19. The device of claim 14, wherein the characteristic of the signal is a Fast Fourier transform (FFT) conversion of the of the signal.

20. The device of claim 14, wherein the characteristic of the signal is used to generate a spectrogram associated with differing flickering patterns, associated with the signal corresponding to the light flicker, changing over time and space.

21. The device of claim 14, wherein said determining the location of the device within the physical environment is further based on:
audio data obtained within the physical environment;
image data obtained within the physical environment; or
motion sensor data obtained within the physical environment.

22. The device of claim 14, wherein said determining the location of the device within the physical environment is further based on sensor data, from multiple sensors, periodically changing over time.

23. The device of claim 14, wherein said determining the location of the device within the physical environment is further based on additional localization events.

24. The device of claim 14, wherein the light sensor is integrated with the device.

25. A non-transitory computer-readable storage medium storing program instructions executable via one or more processors of a device to perform operations comprising:
obtaining, via a light sensor, a signal corresponding to light flicker from one or more light sources within a physical environment;
comparing a characteristic of the signal associated with the light flicker from the one or more light sources with predetermined flicker profile data, the predetermined flicker profile data identifying one or more flicker attributes associated with one or more locations within the physical environment; and
based on the comparing, determining a location of the device within the physical environment.
